(19) United States
(12) Patent Application Publication
(10) Pub. No.: US 2010/0292111 A1
(43) Pub. Date: Nov. 18, 2010

(54) LUBRICANT WITH FLUORESCENT TRACER FOR CONVEYOR CHAINS

(75) Inventors: Maria Cristina Villalobos Sandoval, Guadalupe (MX); Rafael Ornelas Vicencio, Juarez (MX); Sara Treviño Garza, Monterrey (MX)

Correspondence Address: MICHAEL WINFIELD GOLTRY, 4000 N. CENTRAL AVENUE, SUITE 1220, PHOENIX, AZ, 85012, US

(73) Assignee: QUIMIPRODUCTOS, S. A. DE C. V., San Nicolas de los Garza (MX)

(21) Appl. No.: 12/778,815

(22) Filed: May 12, 2010

(30) Foreign Application Priority Data
May 12, 2009 (MX) MX/A/2009/005061

(51) Int. Cl. C07F 7/08

(52) U.S. Cl. 508/207

(57) ABSTRACT

A lubricant for conveyor chains for bottled products that has a direct application, without dilution, to form a layer or film of lubricant on the surface of the conveyor chain, where the application is continuous at prolonged intervals between the applications, so that the lubricant for the conveyor chains can be observed under UV light in order to verify the existence and correct application of said lubricant. The lubricant is composed from 1% to 50% in weight of silicon fluid; from 5% to 80% in weight of fatty acid; from 2% to 50% in weight of amine; from 5% to 50% in weight of hydrocarbon; from 5% to 30% in weight of emulsifier; from 10% to 80% in weight of polyglycol; and from 0.001% to 10% in weight of fluorescent tracer selected from a group consisting of fluorescent whitening agent, benzoxazole thiophene, aminotriazine formaldehyde co-condensates with organic dyes, and combinations thereof.

### TECHNICAL FIELD OF THE INVENTION

The present invention relates generally to lubricating fluids, and particularly to a lubricant with a fluorescent tracer applied directly, without dilution, on conveyor chains, capable of producing a layer of lubricant that is visible under ultraviolet light, and the use of which is convenient apart from lubricating, avoiding the proliferation of germs, and not producing a reaction with spilled products, materials of the premises and of the containers used in the bottled products, also serves as a means of control of the existence of said lubricant.

### BACKGROUND OF THE INVENTION

At present drinks, food, or bottled products are available in different types of containers, such as glass, plastic or PET bottles, plasticized recipients, as well as metal cans, etc., whereby during processing and bottling it is necessary to transport the empty and/or full containers from one place to another, during the different stages of the industrial process to which they are submitted, using conveyor chains generally made of stainless steel or plastic, which provokes a constant friction between the conveyor chains and the containers, between the components of the conveyor chains, as well as the mutual collision among the containers during transportation.

Based on the aforementioned, a result of uncontrolled friction, of an inappropriate lubrication of the settings of the conveyor chains, may be a series of unfavorable situations, such as the containers tipping over or obstructing the passage (even though the conveyor chains continue operation), or otherwise, provoke more noise and discontinuity in the feeding or supply of containers to the following stages in the process, for example in the filling or labeling stages. Therefore, these situations may lead to a low performance in the stages of the process, provoking an accelerated wear of the conveyor chains and force the capacity of the motors, all the former because of an inappropriate lubrication.

At present, in order to control the effect of friction, it is common to use lubricants that are applied on the conveyor chains, and that are divided basically into two main groups as follows:

1. Lubricants based on soap, and

2. Lubricants based on fatty amines.

The common and characteristic disadvantage of each of these groups of lubricants is that to be applied on conveyor chains, they need to be diluted in great amounts of water, in concentrations from 0.1% to 1.0% of the lubricant, whereby the water is the remaining 99.0% to 99.9%; therefore resulting in a high water consumption, thus in a high operational cost.

Another common disadvantage of both lubricant groups is its permanence on the surface of the conveyor chains, that is, forming a lubricant layer that tends to disappear too rapidly, therefore requiring constant or very frequent applications on the conveyor chains; the reason for this, among other causes is that the lubricants have been diluted in high concentrations of water.

Additionally, in the specific case of lubricants based on soap that can relatively easily be applied, but present disadvantages such as their sensibility to the hardness of water which results in the plugging of the lubricant application sprays, therefore, they should be used with softened water and/or, if missing, use inhibiting agents by their composition, as for example EDTA (ethylene diamine tetra-acetic acid or its salts). Moreover, the use of these inhibiting agents provokes an impact on the environment as they are very little biodegradable.

Another current disadvantage in the lubricants based on soap is the excessive foam that may be spilled on the floor, and consequently present an accident risk for the personnel, moreover, it affects the aspect of the premises, floors, and the transported product.

An additional disadvantage of this type of lubricants is that they provoke the proliferation of micro-organisms and biomasses in the conveyor chains, floors, and drainage, which leads to frequent cleaning and disinfection of the premises.

Related to the second type of lubricants based on fatty amines, lubricants were found based on primary neutralized fatty amines, secondary and tertiary amines, and polyamines.

Lubricants based on amines present the additional disadvantage that their lubricating effect is affected when applied on high speed conveyor chains, therefore, their application is limited to low or medium speed conveyor chains.

This type of lubricants does not present the disadvantages to react with the hardness of water, or to favor the proliferation of micro-organisms or biomasses compared with the lubricants based on soap, but due to their composition they have a low biodegradability, and moreover, particularly lubricants based on polyamines, due to their composition, tend to react with the contents of the product spilled on the conveyor chain.

Among the proposals for a solution to counter the above mentioned limitations, polyalkylene-glycol was found to be used as a base for the composition of the lubricant. Some examples of current solutions are described hereunder:

Minyu Li, Person Hei Kim and Amy Haupert, in the patent of the United States U.S. Pat. No. 6,855,676 B2, describe a lubricant composition for conveyor chains that contains polyalkylene-glycol, fatty acid and neutralizing agents.

Minyu Li, Person Hei Kim and Amy Haupert, in the patent application of the United States US-2004/0053793 describe a lubricant composition for conveyor chains that contains polyalkylene-glycol, fatty acid, anionic surfactant, and neutralizing agents.

Minyu Li, Person Hei Kim and Amy Haupert, in the patent application of the United States US-2005/0059564 describe a lubricant composition for conveyor chains consisting of polyalkylene-glycol, fatty acid, monomeric polyol, and neutralizing agents.

The disadvantage of these lubricants is that because of their transparency it is difficult to verify at a glance, the presence and correct application of said lubricants on a conveyor belt, so there is a clear need to offer a lubricant that is applied directly, without dilution, on conveyor chains, capable of producing a layer of lubricant that is visible under UV light, and with a convenient use, apart from lubricating, also avoids the proliferation of germs without reacting to spilled products, materials of the premises and the containers used for bottled products, as well as serves as a control means for the presence and correct application of said lubricant.

### SUMMARY OF THE INVENTION

In view of the above, it is the purpose of the present invention to provide a lubricant for conveyor chains for bottled products that has a direct application, without dilution, to form a layer or film of lubricant on the surface of the conveyor chain, where the application is continuous at prolonged intervals between the applications, so that the lubricant for the conveyor chains can be observed under UV light in order to verify the existence and correct application of said lubricant. The lubricant is composed from 1% to 50% in weight silicone fluid, from 5% to 80% in weight of fatty acid, from 2% to 50% in weight of amine, from 5% to 50% in weight of hydrocarbon, from 5% to 30% in weight of emulsifier; from 10% to 80% in weight of polyglycol, and from 0.001% to 10% in weight of fluorescent tracer selected from a group consisting of fluorescent whitening agent, benzoxazole thiophene, aminotriazine formaldehyde co-condensates with organic dyes, and combinations thereof.

### DETAILED DESCRIPTION OF THE INVENTION

The characteristic details and composition of the lubricant with fluorescent tracer for conveyor chains are described in the following paragraphs, which are for the purpose of defining the characteristics and composition of the lubricant without limiting its scope.

The lubricant with fluorescent tracer for conveyor chains according to the invention shows components which in turn may consist of multiple components.

The components are described individually below, without necessarily being described in any order of importance.

### Component I

The lubricant with fluorescent tracer for conveyor chains contains component I, which is one or more silicon fluids. Silicon fluids, silicon or silicon terms designate all fully synthetic products with molecules that consist of alternating atoms of silicon and oxygen to which various organic radicals may arranged, in fact, the silicon molecules are chains of silicon and oxygen atoms, so that the possibility of overlapping appears immediately. It is understood that said structure allows the construction of very different polymers.

In the case of the lubricant with fluorescent tracer for conveyor chains of the present invention, a structure of silicon-organic polymer is arranged with an oily liquid appearance that allows the lubrication of metal parts without dissociation of molecules, and without being affected by temperature variations. Within the silicon fluids used, there are the ones provided by General Electric®, such as the dimethyl fluids of series SF-96, SF-78350, the alkyl phenyl fluids of series SF-1147, SF-8843, SF-1154, and SF-1550; the organ functional fluids of series SF-1705, SF-1708, SF-1923, and SF-1921; hydroxy fluids and metoxy fluids. Preferably, alkyl phenyl fluids would be used for the present invention to apply on metallic conveyor chains in order to penetrate areas difficult-to-reach.

Other silicon fluids that can be used as component I are polydimethylsiloxane, dimethylsiloxane, alkyl siloxane, phenyl siloxane, chlorosilanes as well as silicon emulsions formed from methyl dimethyl silicone, alkyl siloxanes, arylsiloxane and chlorosilanes, that because of their chemical characteristics that contribute to the lubricant properties of easy application, low superficial tension, excellent water repellence, high temperature stability, good lubrication, moreover to be used at low concentrations.

### Component II

The lubricant with fluorescent tracer for conveyor chains contains component II, which is one or more fatty acids, increasing the lubricity of the lubricant of this invention, so that it can be used in containers of different materials such as metal, glass, plastic, plasticized container, etc.

The fatty acid consists of an alkyd chain with a terminal carboxylic group, being the simplest configuration the completely saturated lineal chain. Fatty acids are classified in fatty acids of short, medium, and long chains, and through their saturation grade in saturated and unsaturated, the latter divided in turn in mono-unsaturated fatty acids and poly-unsaturated acids.

The lubricant for conveyor chains of bottled products uses saturated, unsaturated or substituted fatty acids with a scope of 8 to 22 atoms of carbon. Among the saturated fatty acids there may be, for example, the caprylic acid of 8 carbon atoms, the capric acid of 10 carbon atoms, the undecylic acid of 11 carbon atoms, the lauric acid of 12 carbon atoms, the tridecyl acid of 13 carbon atoms, the myristic acid of 14 carbon atoms, the palmitic acid of 16 carbon atoms, the stearic acid of 18 carbon atoms; among the mono-unsaturated fatty acids there may, for example, the lauroleic acid of 12 carbon atoms, the myristoleic acid of 14 carbon atoms, the palmitoleic acid of 16 carbon atoms, and preferably the oleic acid of 18 carbon atoms; among the poly-unsaturated fatty acids there may be, for example, the linoleic acid (de-unsaturated) of 18 carbon atoms and the linolenic acid (tri-unsaturated) of 18 carbon atoms, and among the substituted fatty acids there may be, for example, the ricinoleic acid of 18 carbon atoms substituted by hydroxide.

Also, the mixed fatty acids, such as the derivates from greases and oils may be used in the lubricant of this invention, as for example, the fatty acid from coconut oil, or the fatty acid from liquid resin.

### Component III

The lubricant with fluorescent tracer for conveyor chains contains component III that acts as a surfactant, which is one or more amines derived from a fatty acid, characterized by containing alkyl aliphatic groups of 8 to 22 carbon atoms, containing one or more polyethoxylated groups.

The lubricant with fluorescent tracer for conveyor chains uses preferably a tensoactive product derived from an ethoxylated amine which function is to act as a surfactant and is associated with the fat portion of the molecule to provide homogeneity to the lubricant, lubricity, and to serve as an emulsifying and humidifying agent for said lubricant.

Among the former products there may be, for example, ethoxylated amine of coconut, ethoxylated alkyl amine of coconut, ethoxylated alkyl amine of oleic acid, ethoxylated alkyl amine of esteric acid, ethoxylated alkyl amine of tallow fatty acid, ethoxylated alkyl amine of soy, and combinations thereof.

### Component IV

The lubricant with fluorescent tracer for conveyor chains contains component IV as a dissolvent that can be one or more mineral oils or hydrocarbons, aliphatic or benzoic, or combinations thereof. As to the saturated aliphatic hydrocarbon, that can be linear or ramified, there may be, for example, alkanes of the general formula CₙH₂ₙ₊₂ such as heptane, octane, nonane, decanes, pentadecanes, alkenes of the general formula CₙH₂ₙ such as ethane, propene, butane, pentene, and alkynes of the general formula CₙH₂ₙ₋₂ such as ethyne, propine, butane, pentene. Among the aliphatic hydrocarbons the white mineral oils of high purity are preferred, especially formulated for pharmaceutical processes and applications in the agricultural industry. The benzene hydrocarbons may be, for example, those of the general formula CₙH₂ₙ₋₆ such as benzene, toluene, xylenes, and isomers.

### Component V

The lubricant with fluorescent tracer for conveyor chains containing as component V, a non-ionic emulsifier with lypophylic characteristics, ideal for the preparation of water emulsions in oil with a balanced lypophylic and hydrophylic performance. The type of emulsifier performs here an important role in the stability of the emulsion, and it's an advantage to select it from a group that comprises the systems constituted by sorbitan esters and ethoxylated sorbitan esters. As ethoxylated agents there may be, among others, sorbitan monooleate, sorbitan monolaurate, sorbitan monoestearate, sorbitan triestearate, poly-oxietylenated sorbitan trioleate with 14 to 40 ethylene oxide mols, monoolaurate of ethoxylated sorbitan with 11 to 40 ethylene oxide mols, monooleate of polyethylenglycol with a molecular weight between 480 and 1,200, ethoxylated nonilphenol with 6 to 50 ethylene oxide mols.

### Component VI

The lubricant with fluorescent tracer for conveyor chains contains as component VI a polymer selected from co-polymers of a block of polyglycol, particularly polyalkylene-glycol or any other polyalkylene-glycol oxide of a high molecular weight, soluble in water. The polyalkylene-glycol has a general structure as specified below:

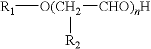

where:

R₁ is hydrogen or alkyl of C₁ to C₄;

R₂ is hydrogen, methyl, or combinations thereof, and

n is an integer.

When R₂ is hydrogen, these materials are polymers of ethylene oxide that are also known as polyethylene glycols. When R₂ is methyl, these materials are polymers of propylene oxide that are also known as polypropylene glycols. When R₂ is methyl, there are also various isomers included, of the resulting polymer position that may exist. Preferred for use in the lubricant of the invention are polyalkylene-glycols, polyethylene glycols, polypropylene glycols, and combinations thereof.

### Component VII

The lubricant with fluorescent tracer for conveyor chains contains component VII, which is one or more fluorescent tracers that can be:

Optical brighteners, optical brighteners agents or fluorescent whitening agents are dyes that absorb light in the ultraviolet and violet region (usually from 340 to 370 nm) of the electromagnetic spectrum and that re-emit light in the blue region (typically from 420 to 470 nm). The fluorescent properties of these brighteners, particularly fluorescent whitening agents, are improved with the reaction of these with the components VI, thus providing a significant increase in emissions of visible blue light.

Examples of fluorescent whitening agents include stilbene derivatives such as triazene-stilbenes (di-, tetra- or hexa-sulfonated), biphenyl-stilbenes and polyester-stilbene; derivates of coumarins such as hydroxycoumarin, aminecoumarin, and phenylcoumarin; imidazolines, diazoles, triazoles, benzoxazolines, bis-bezoxazoles, bis-(esterile) biphyniles, oxazoline, and combinations thereof.

Other fluorescent tracers used in the lubricant of the invention are thiophene of benzoxazole, benzoxazole thiophene, aminotriazine formaldehyde co-condensates with organic dyes, and combinations thereof, and where the organic dyes of aminotriazine formaldehyde co-condensates may be pigmented melanin, sulfonamide, copolymer of formaldehyde.

### Optional Components

As an optional component, the lubricant for conveyor chains for bottled products contains a microbicide to prevent the proliferation of micro-organisms, both in the lubricant itself and on the conveyor chain. Among the microbicides used, there are the isothiazolinones, formaldehyde, gluteraldehyde, etc.

### Mixture

The lubricant for conveyor chains of bottled products combines components I, II, III, IV, V and VI in the following weight percentage concentrations:

(a) from 1% to 50% of silicon fluid (component I);

(b) from 5% to 80% of fatty acid (component II);

(c) from 2% to 50% of amine (component III);

(d) from 5% to 50% of hydrocarbon (component IV);

(e) from 5% to 30% of sorbitan monooleate (component V);

(f) from 10% to 80% of polyalkylene-glycol (component VI); and

(g) from 0.001% to 10% of fluorescent tracer (part VII).

The lubricant for conveyor chains of bottled products of the present invention shows the following contents in weight percentage concentrations:

(a) from 1% to 10% of polydimethylsiloxane (component I);

(b) from 5% to 25% of fatty acid (component II);

(c) from 2% to 15% of ethoxylated alkyl amine of soy (component III);

(d) from 5% to 20% of hydrocarbon (component IV);

(e) from 5% to 15% of sorbitan monooleate (component V);

(f) from 20% to 50% of polyalkylene-glycol (component VI); and

(g) from 0.001% to 10° A) of fluorescent tracer (part VII).

### Examples of Embodiments of the Invention

The invention will now be described in reference to the following examples, which is solely for the purpose of presenting the way of carrying out the implementation of the principles of the invention. The following examples do not intend to be a comprehensive representation of this invention, neither to limit the scope of said invention.

Table 1 shows examples of the lubricant composition for conveyor chains for bottled products with the weight percentage of each component:

TABLE 1

| | Weight percentage of each component | | |
|---|---|---|---|
| Compound | Example 1 | Example 2 | Example 3 |
| Polydimethylsiloxane | 5.0 | 1.0 | 10.0 |
| Oleic acid | 17.0 | 17.0 | 17.0 |
| Ethoxylated alkyl amine of soy | 9.0 | 9.0 | 9.0 |
| Hydrocarbon | 14.0 | 14.0 | 14.0 |
| Sorbitan monooleate | 14.0 | 14.0 | 14.0 |
| Polyalkylene-glycol | 41.0 | 45.0 | 36.0 |
| Fluorescent whitening agent | 0.001 | 0.5 | 2.0 |

### Preparation Mode

The lubricant for conveyor chains for bottled products is prepared mixing first the hydrocarbon (component IV) with the silicon fluid (component I), proceeding then to shake, adding the fatty acid (component II) and the amine (component III). Finally, sorbitan monooleate is added (component V), the polyalkylene-glycol (component VI) and the fluorescent tracer (component VII) to the mixture, stirring for about 20 minutes or until the mixture is homogeneous.

### Application Mode

The lubricant with fluorescent tracer for conveyor chains of bottled products is applied directly on the plastic and/or metallic surface of the chain without adding any extra dissolvent, through the preferred use of a broad plastic brush with nylon bristles (with a thickness of approximately 0.38 mm) that allows an adequate distribution of the lubricant along the conveyor chain to form a permanent layer or film of lubricant on the surface of said conveyor chain.

Another application form is through the use of manual or automatic sprayers that spray the conveyor chain surface with the lubricant.

In both cases the lubricant is applied directly without diluting on the transport chain, to form a lubricant layer that adheres to the surface of the conveyor chain for a period that can be up to 8 hours.

### Measurement of the Frictional Index at Laboratory Level

The friction index, defined as the force performed by the containers against the movement of the conveyor chain divided by the weight of the containers, obtained during laboratory testing on a dose of lubricant between 3 to 10 millilitres, that is, 0.07 to 0.12. The friction index when applying the lubricant of this invention is obtained at laboratory level, through the use of a certain amount of full bottles on a conveyor chain to provoke a stress force that is measured with a dynamometer. The full bottles are secured with a tape and the latter in turn to the dynamometer; next, the conveyor chain is operated after applying the lubricant directly on the conveyor; the dynamometer readings are taken every 5 or 10 minutes as needed until the lubricant is finished. The friction index is calculated by averaging the readings of the dynamometer, dividing by the total weight in grams of the filled bottles.

Lubrication tests were performed at laboratory level using the lubricant compositions of the present invention in Table 1 and whose results are shown in tables 2, 3, and 4.

Test Conditions of Lubrication:

Stainless steel chain

Speed of 40.8 m/min

Friction coefficient=value/total weight of bottles

Total weight of glass bottles=2,898.7 g

Total weight of PET bottles=4,212.1 g

Total weight of steel=3,000 g

Measurement equipment: dynamometer EXTECH brand

### Measurement of Presence of Lubrication

The presence of the lubricant and uniformity in its application over the conveyor chain was done visually by using an ultraviolet lamp to produce light emission in the lubricant. During the measurement test of the friction index in the laboratory, a UV light of 254 nm and 365 nm of 6 Watts of a handheld UV lamp, model UVGL-58 IECS brand (Internacional de Equipos Cientificos, S.A. de C.V.) passed over the chain and parts of the conveyor to visualize the lubricant distribution, presenting the latter a blue color where it was found. The measurement performed is visual, reporting whether there is coloring or not, under ultraviolet light.

The lubrication tests to verify the existence and correct application of the lubricant at laboratory level were performed, using the lubricant compositions of the present invention in Table 1 and whose results are shown in tables 2, 3, and 4.

TABLE 2

| | Lubrication Test Results of Lubricant of Example 1 of Table 1 | | | | | | | | |
|---|---|---|---|---|---|---|---|---|---|
| | Glass Bottles | | | PET Bottles | | | Metal container | | |
| | | | Presence | | | Presence | | | Presence |
| | | | and proper | | | and proper | | | and proper |
| | | Friction | application | | Friction | application | | Friction | application |
| Reading | Value | Index | of lubricant | Value | Index | of lubricant | Value | Index | of lubricant |
| 0 | 994 | 0.3429 | Yes | 1247 | 0.303 | Yes | 697 | 0.317 | Yes |
| 1 | 229 | 0.079 | Yes | 422 | 0.100 | Yes | 263 | 0.087 | Yes |
| 2 | 245 | 0.084 | Yes | 357 | 0.084 | Yes | 234 | 0.078 | Yes |
| 3 | 222 | 0.076 | Yes | 368 | 0.087 | Yes | 252 | 0.084 | Yes |
| 4 | 248 | 0.085 | Yes | 344 | 0.081 | Yes | 248 | 0.082 | Yes |
| 5 | 241 | 0.083 | Yes | 360 | 0.085 | Yes | 228 | 0.076 | Yes |

TABLE 3

| | Lubrication Test Results of Lubricant of Example 2 of Table 1 | | | | | | | | |
|---|---|---|---|---|---|---|---|---|---|
| | Glass Bottles | | | PET Bottles | | | Metal container | | |
| | | | Presence | | | Presence | | | Presence |
| | | | and proper | | | and proper | | | and proper |
| | | Friction | application | | Friction | application | | Friction | application |
| Reading | Value | Index | of lubricant | Value | Index | of lubricant | Value | Index | of lubricant |
| 0 | 994 | 0.3429 | Yes | 1247 | 0.303 | Yes | 697 | 0.317 | Yes |
| 1 | 222 | 0.076 | Yes | 348 | 0.082 | Yes | 255 | 0.085 | Yes |
| 2 | 218 | 0.075 | Yes | 268 | 0.063 | Yes | 222 | 0.074 | Yes |
| 3 | 237 | 0.081 | Yes | 271 | 0.064 | Yes | 232 | 0.077 | Yes |
| 4 | 226 | 0.077 | Yes | 283 | 0.067 | Yes | 226 | 0.075 | Yes |
| 5 | 241 | 0.083 | Yes | 265 | 0.062 | Yes | 237 | 0.079 | Yes |

TABLE 4

| | Lubrication Test Results of Lubricant of Example 3 of Table 1 | | | | | | | | |
|---|---|---|---|---|---|---|---|---|---|
| | Glass Bottles | | | PET Bottles | | | Metal container | | |
| | | | Presence | | | Presence | | | Presence |
| | | | and proper | | | and proper | | | and proper |
| | | Friction | application | | Friction | application | | Friction | application |
| Reading | Value | Index | of lubricant | Value | Index | of lubricant | Value | Index | of lubricant |
| 0 | 994 | 0.3429 | Yes | 1247 | 0.303 | Yes | 697 | 0.317 | Yes |
| 1 | 237 | 0.081 | Yes | 357 | 0.084 | Yes | 265 | 0.088 | Yes |
| 2 | 223 | 0.076 | Yes | 342 | 0.081 | Yes | 271 | 0.090 | Yes |
| 3 | 241 | 0.083 | Yes | 360 | 0.085 | Yes | 259 | 0.086 | Yes |
| 4 | 230 | 0.079 | Yes | 352 | 0.083 | Yes | 275 | 0.091 | Yes |
| 5 | 253 | 0.087 | Yes | 373 | 0.088 | Yes | 269 | 0.089 | Yes |

Finally, it will be understood that the lubricant composition for conveyor chains of the present invention are not limited to the modality or manners described above and that experts in the field will be trained by the teachings herein, to make changes in the composition of the lubricant for conveyor chains of the present invention, with a reach that will be established exclusively by the following claims:

1. A lubricant for conveyor chains, comprising:
from 1% to 50% in weight of silicon fluid;
from 5% to 80% in weight of fatty acid;
from 2% to 50% in weight of amine;
from 5% to 50% in weight of hydrocarbon;
from 5% to 30% in weight of emulsifier;
from 10% to 80% in weight of polyglycol; and
wherein the lubricant includes from 0.001% to 10% in weight of fluorescent tracer selected from a group consisting of fluorescent whitening agent, benzoxazole thiophane, aminotriazine formaldehyde co-condensates with organic dyes, and combinations thereof.

2. The lubricant of claim 1, wherein comprising from 1% to 10° A) in weight of silicon fluid.

3. The lubricant of claim 1, wherein the silicone fluid is selected from a group consisting of polydimethylsiloxane; dimethylsiloxane; alkyl siloxane; phenyl siloxane; chlorosilanes; silicon emulsions formed from methyl dimethyl silicone, alkyl siloxanes, arylsiloxane and chlorosilanes; and combinations thereof.

4. The lubricant of claim 3, wherein the silicon fluid is polydimethylsiloxane.

5. The lubricant of claim 1, wherein comprising from 5% to 25% in weight of fatty acid.

6. The lubricant of claim 1, wherein the fatty acid is from 12 to 22 atoms of carbon.

7. The lubricant of claim 6, wherein the fatty acid is oleic acid.

8. The lubricant of claim 1, wherein comprising from 2% to 15% in weight of amine.

9. The lubricant of claim 1, wherein the amine is a tensoactive product derived from an ethoxylated amine selected from a group consisting of ethoxylated amine of coconut, ethoxylated alkyl amine of coconut, ethoxylated alkyl amine of oleic acid, ethoxylated alkyl amine of esteric acid, ethoxylated alkyl amine of tallow fatty acid, ethoxylated alkyl amine of soy, and combinations thereof.

10. The lubricant of claim 1, wherein comprising from 5% to 20% in weight of hydrocarbon.

11. The lubricant of claim 1, wherein the hydrocarbon is selected from a group consisting of aliphatic hydrocarbons, benzene hydrocarbons, alcohols and combinations thereof.

12. The lubricant of claim 1, wherein comprising from 5% to 15% in weight of emulsifier.

13. The lubricant of claim 1, wherein the emulsifier is sorbitan monooleate.

14. The lubricant of claim 1, wherein comprising from 20% to 50% in weight of polyglycol.

15. The lubricant of claim 1, wherein the polyglycol is polyalkylene-glycol selected from a group consisting of polyalkylene-glycols, polyethylene glycols, polypropylene glycols, and combinations thereof.

16. The lubricant of claim 1, wherein comprising from 0.01% to 5% in weight of fluorescent tracer.

17. The lubricant of claim 1, wherein the fluorescent whitening agent is selected from a group consisting of triazene-stilbenes (di-, tetra- or hexa-sulfonated), biphenyl-stilbenes, polyester-stilbene, hydroxycoumarin, aminecoumarin, phenylcoumarin, imidazolines, diazoles, triazoles, benzoxazolines, bis-bezoxazoles, bis-(esterile) biphyniles, oxazoline, and combinations thereof.

18. The lubricant of claim 1, wherein the organic dye of the aminotriazine formaldehyde co-condensates is selected from a group consisting of pigmented melanin, sulfonamide, formaldehyde copolymer, and combinations thereof.

19. The lubricant of claim 1, wherein further comprising a microbicide selected from a group consisting of isothiazolinones, formaldehyde, gluteraldehyde, and combinations thereof.

20. The lubricant of claim 1, wherein the lubricant is applied directly without diluting on the surface of the conveyor chain by using a plastic bristle brush or by spraying with the use of sprays.

21. The lubricant of claim 20, wherein the brush bristles are of nylon plastic.
